(19) United States
(12) Patent Application Publication
(10) Pub. No.: US 2004/0046743 A1
(43) Pub. Date: Mar. 11, 2004

(54) Device and a method for presenting information to a keyboard operator

(75) Inventors: Hans Ekstrom, Kilafors (SE); Samuel Jonsson, Hallstahammar (SE)

Correspondence Address: George M. Kaplan, Esq., DILWORTH & BARRESE, LLP, 333 Earle Ovington Blvd., Uniondale, NY, 11553, US

(73) Assignee: INECT HB

(21) Appl. No.: 10/236,440

(22) Filed: Sep. 6, 2002

(51) Int. Cl. G09G 5/00

(52) U.S. Cl. 345/168

(57) ABSTRACT

The invention relates to a device (1) for presenting information to a keyboard operator (40) in connection with feeding of characters to a computer (3) that comprises a central unit, a keyboard (6) and a screen (4), wherein the device is adapted for acting together with the computer and the device comprises a connection unit (2) adapted for connecting the device to the computer and at least one information presenting member (12), wherein the device is arranged so that it informs the operator about which characters he last fed to the computer, and so that it is possible for the operator to direct his eyes towards the keyboard, meanwhile receiving information about said feeding of characters.

### FIELD OF THE INVENTION

The present invention relates to a device for presenting information to a keyboard operator in connection with feeding of characters to a computer that comprises a central unit, a keyboard, and a screen unit, wherein the device is adapted for acting together with a computer.

Further, the invention relates to method for presentation of characters being fed by an operator via a keyboard to a computer comprising a screen unit, on which screen the fed characters are presented.

### PRIOR ART

With a computer is referred to a portable computer as well as a stationary one. Further, the computer refers to personal computers as well as workstations. In the following, a computer, constituted by a stationary computer having a separate keyboard, a screen unit, and a central unit will be explained. This area of application is discussed only as an example and the invention is not limited to this area. During usage of a computer it is impossible to see both the keyboard and the screen at the same time, since they are separated.

People today, who wish to follow the technical development in the society, must be able to handle a computer. Many of these people do not have the writing technique, i.e. character feeding technique, that enables them to quickly and correctly feed the characters without needing to look down at the keyboard and their fingering.

When someone is working with a computer, it is common to alternate between looking down at the keyboard when performing the feeding of the characters and looking up at the screen to ensure a correct feeding. This alternating movement of the eyes between the keyboard and the screen leads to the eyes having to adjust the visual acuity depending on the distance. It often happens that the operator feels tired after a long period of time of feeding characters, which at least partly depends on the fact that the eyes constantly have to adjust the visual acuity to the distance. Beside the fact that such frequent movements of the eyes lower the concentration, they also take time. A device that enables an operator to focus on pressing the keys and at the same time be informed about the fed characters, without having to look up at the screen, would increase his speed of writing.

In this application, a user of a computer is denoted an operator. The operator communicates with the computer by, feeding characters to the computer via the keyboard and reading the fed characters on the screen of the computer. Characters being fed by the operator comprise letters, figures, and other signs that normally are used in connection with usage of computers, for example spacing.

### OBJECTS AND SUMMARY OF THE INVENTION

The object of the present invention is to provide a device that, in a simple manner, assists an operator in increasing his writing speed when using a computer. In particular, the purpose is to obtain a means for assisting operators who need to look down at the keyboard to be able to effectively perform the feeding of characters.

This object is obtained by means of the initially defined device, characterized in that it comprises a connection unit adapted for connecting the device to the computer and at least one information presenting member, wherein the device is arranged so that it informs the operator about which characters he last fed to the computer, and so that it is possible for the operator to direct his eyes towards the keyboard, meanwhile receiving information about said feeding of characters.

By using such a complementary device together with a computer, the operator is enabled to increase his writing speed. Thanks to the fact that the information presentation member is arranged in such a manner that it continuously informs the operator about which characters he has been feeding, it is possible for the operator to rest his eyes on the keyboard and thereby quickly find the right keys. Thus, the device reduces the risk for pressing the wrong key, which also saves time. Further, the operator gains time, since he does not have to look up at the screen a number of times to check the fed characters.

According to an embodiment of the invention, the information presenting member comprises a display unit which is arranged for visualizing the feeding of characters within the operator's range of vision when he directs his eyes towards the keys of the keyboard. Through this embodiment, the operator does not have to look at the screen to obtain information about fed characters. Thus, trying work for the eyes is avoided, since they does not have to adjust the visual acuity depending on the distance which varies in dependence of whether the operator looks at the keyboard and his fingering at the screen.

According to a further embodiment of the invention, the displaying unit is located in a rear section of the keyboard, such that the displaying unit is located in front of the hands of the operator when he performs the feeding of the characters. Such a location of the displaying unit does not impede the operator's feeding of characters. Further, the displaying unit is arranged in such a manner that the hands of the operator do not hide the displaying unit. Thereby the device achieves the object without disturbing the operator.

According to a further embodiment of the invention, the displaying unit is designed to be located between two existing rows of keys on the keyboard. Such an arrangement locates the device within in the range of vision of the operator, when he directs the eyes towards the keyboard.

According to a further embodiment of the invention, the displaying unit is arranged such that each newly fed character shifts the previously fed characters to the left as seen from the operator. Since the presented characters are shifted to the left when new characters are fed, the characters will move from one end of the displaying unit to the other as a so-called scroll or lateral feeding. When you read a text, there has to be a relative movement between the eyes and the characters that forms the text. Instead of the eyes having to work from the left to the right during the reading, the displaying unit is arranged in such a manner that the shown characters move in an opposite direction and accordingly the same effect will be achieved. Thanks to the fact that the signs shown on the displaying unit move in such a manner, the operator may rests his eyes on the displaying unit on the keyboard during reading. Thus, the presentation of characters on the displaying unit differs from the presentation on a traditional screen, since the eyes must be moved after the last fed characters during the reading on a traditional screen. During reading the eyes must be moved along the row of characters and also downwards when changing to a new row.

According to a further embodiment of the invention, the displaying unit is provided with a screening member arranged for preventing others than the operator from seeing the visualized characters. This arrangement is advantageous for example when feeding a password, in crowded surroundings. Then, the operator may switch off the screen and still be able to view the feeding of characters on the displaying unit, which is screened such that surrounding people are not allowed to see what is shown thereon.

According to a further embodiment of the invention, the device is integrated in the keyboard. Such an arrangement creates ergonomic independence for the operator. In such an embodiment, the displaying unit can be joined to the keyboard. The operator does not have to sit in such a manner that he looks at the screen, since the displaying unit visualizes the characters lastly fed. Accordingly, the operator, if he wishes to, can places the keyboard in the lap when he is working.

According to a further embodiment of the invention, the displaying unit is foldable between an open position and a closed position. In the closed position the displaying unit is turned down against the keyboard and in the open position the displaying unit is put up from the keyboard. A foldable displaying unit is advantageous, for example when the computer is to be moved, since the risk for damages on the displaying unit is reduced when it is in the closed position.

According to a further embodiment of the invention, the device is formed as a separate unit relative to the computer and the connection unit is adapted for being matched to the computer. Accordingly, it is possible for the operator to bring the device with him and use the device in connection with all computers that he uses. Thanks to the fact that the device constitutes a movable unit, it may be placed in a position suitable for the operator. The operator who is about to write a text may place the device on the keyboard. This is particularly advantageous for someone who cannot effectively handle the feeding of characters without looking at the keys and his fingering. The operator who is about to make a copy of a printed text may place the device on the printed text, close to the text to be copied. This is particularly advantageous for someone who can handle the feeding of characters effectively without looking at the keyboard. In both the above described cases, the operator does not have to turn or bend his head, which is the case in the traditional use of computers. By use of the device during feeding of characters to a computer, a reduction of trying stress on the neck is achieved.

According to a further embodiment of the invention, the connection unit comprises a first contact member for interaction with the computer and a second contact member for interaction with the keyboard, for the purpose of providing the information presenting member with data passing from the keyboard to the central unit of the computer. The device with the connection unit is adapted to be easily connectable to conventional computers. Accordingly, the operator may easily and quickly connect the device to the computer that we wish to use.

According to a further embodiment of the invention, the device is driven by means of an electric voltage available in the connection device of the computer. Therefore, it is not necessary to have any external current source. Thanks to the fact that the existing voltage in the computer is used, the device can be made smaller and more flexible. The device may advantageously be driven by the electric voltage being accessible in the connection device of the computer, to which the keyboard is to be connected. In this connection device there is current available, which is not used by the computer. Thus, it is beneficial to utilize the connection device of the computer as a current source, since this voltage is enough for driving both the device and the keyboard in such a manner that the signals from the keyboard are not disturbed.

A further object of the present invention is to provide a method that allows an operator to easily and quickly feed characters to a computer.

The object is achieved by a method for presentation of characters, which are fed by an operator via a keyboard to a computer comprising a screen unit, wherein the fed characters are presented on the screen unit and the fed characters are also presented visually in immediate connection to the keyboard, so that the operator is allowed to direct his eyes towards the keyboard and type at the same time as he views at least the last fed characters. By the use of such a method, it is possible for the operator to see, within his range of view, his keyboard fingering and the last fed characters at the same time, which creates possibilities for an effective feeding of characters. According to an embodiment of the invention, the fed characters are presented on a device, which is connected to the computer, and when the operator feeds the characters, data corresponding to the fed characters are transmitted to both the computer and the device. Thanks to the fact that the key pressing can be interpreted directly from the keyboard, the presentation of the characters is independent of which text-processing program or editor the computer uses.

Further characterizing features of and advantages with the device according to the invention will appear in the following detailed description.

### BRIEF DESCRIPTION OF THE DRAWINGS

The invention will now be explained more closely by the description of different embodiments thereof and with reference to the appended figures.

FIG. 1 shows a first embodiment of the device according to the invention together with a computer.

FIG. 2 shows schematically a block scheme of the device according to the invention.

FIG. 3 shows a second embodiment of the device according to the invention together with a computer.

FIG. 4 shows a third embodiment of the device according to the invention together with a computer.

FIG. 5 shows a forth embodiment of the device according to the invention together with a computer.

### DETAILED DESCRIPTION OF PREFERRED EMBODIMENTS

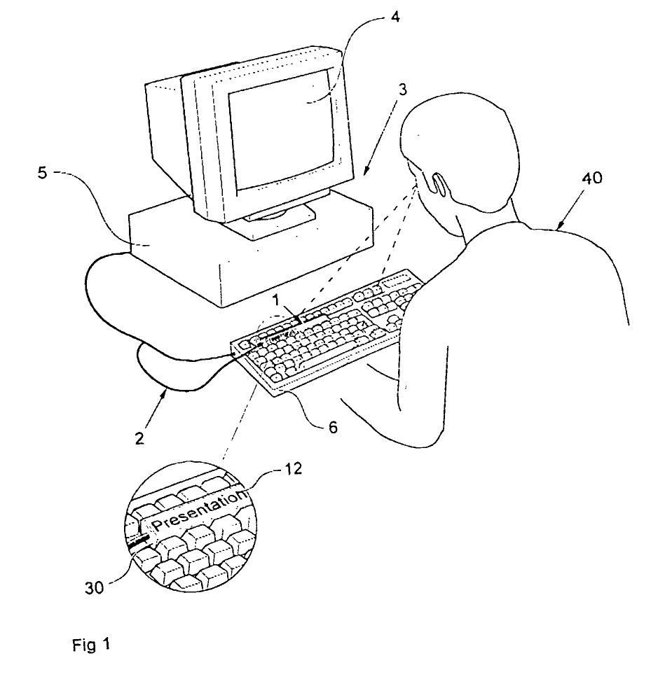

FIG. 1 shows a first embodiment of the device 1 according to the invention for presenting information to a keyboard operator 40. The device 1 is connected to a computer 3 via a connection unit 2. The computer 3 is of a conventional type and comprises a screen unit 4, a central unit 5, and a keyboard 6.

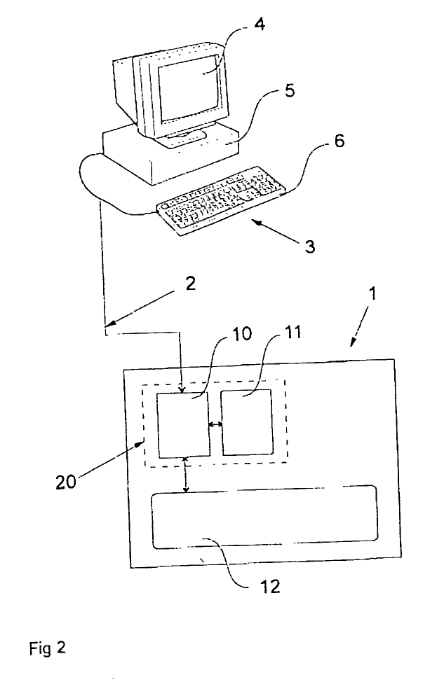

As shown in FIG. 2, the device 1 comprises, beside the connection unit 2, a processing unit 10, a memory unit 11, and at least one information presenting member, as well as a communication path between them. In this first embodiment, the information presenting member is a display unit 12, for example an ordinary display. The display unit 12 is adapted for presenting fed characters to the keyboard operator 40. The device 1 is intended for assisting the operator 40 in his feeding of characters in such a manner that he, in his range of view, can see both the fed characters on the display 12 and his keyboard fingering 6 simultaneously.

In the first embodiment, the device 1 is a separate unit relative to the computer 3 and is arranged to be a small mobile unit, which is possible for the operator to carry with him, for example in a pocket. The connection unit 2 of the device 1 is adapted for being matched to the computers of today, and thus the device 1 may be used together with any conventional computer.

When the operator 40 presses one or several keys on the keyboard 6, data comprising information about which key or keys have been pressed, are transferred to the processing unit 10. In the memory unit 11, program codes are stored. This program code comprises a table of data corresponding to all essential key pressings and instructions about how data shall be handled in the processing unit 10 and presented on the display 12. When the processing unit 10 has received data from the keyboard 6, the data are identified by a comparison between received data and data stored in the table. The processing unit 10 performs the comparison. When data has been identified, the processing unit 10 carries out the instructions, which are coupled to the identified data. The device 1 is arranged for interpreting the key pressings from the keyboard 6 and accordingly the presentation of characters will be independent of which text processing program or editor is used by the computer 3.

If the operator 40, for instance, at the same time presses the key “Shift” and “a”0 at the keyboard 6, data comprising information corresponding to those key pressings will be transmitted from the keyboard 6 to the central unit 5 of the computer 3 and via the connection unit 2 to the processing unit 10 of the device. By using the table stored in the memory unit 11, the processing unit 10 identifies the pressed keys, and carries out instructions, which results in the sign A being presented on the display. Thus, the display 12 is provided with data passing from the keyboard 6 of the computer to the central unit 5. Thereby, the characters which are coupled to the pressed key is shown both on the display 12 of the device 1 and on the screen 4 of the computer 3. The display 12 constitutes a complement to the screen 4 of the computer 3 for presentation of characters. The display 12 increases the speed of feeding of the operator 40.

As shown in FIG. 2, the connection unit 2, the memory unit 11, and the display 12 are connected to the processing unit 10. The processing unit 10 and the memory unit 11 may either compose one unit or be arranged as separate units. The processing unit 10 can be a microprocessor of any type. Depending on the choice, the processor may comprise an oscillator and a capacitor for generation of clock pulses. Preferably, the processing unit 10 and the memory unit 11 are arranged on one chip, a so-called One Chip Processor (OCP) 20. A capacitor and a crystal oscillator are also used together with such a one-chip processor 20 and are mounted on the same circuit board, which has suitable connectors. The one-chip processor 20 handles data corresponding to the fed characters. The one-chip processor 20 comprises a serial input port and one 8-byte and one 4-byte parallel port. In the one-chip processor 20, the processing unit 10 and the memory unit 11 are cooperating. The memory unit 11 comprises a read memory for example a Programmable Read Only Memory (PROM). The display unit 12 is connected via the 8-byte parallel port of the processing unit 10.

The display 12 can be a display of a conventional LCD-type and have a size such that the operator 40 without any problem can see the characters. Preferably, a LCD-display comprising power electronic is used. Otherwise, the power electronic could also be arranged on said circuit board. Such a display 12 may, for example, show two rows of characters, preferably, however, show only one row. Further, the display 12 can, simultaneously handle and present a plurality of characters, preferably about 40 characters. Other types of displays showing either more or less characters, for example between 5 and 50 characters, can also be used. Preferably, the display 12 comprises a character memory for this presentation of characters. However, the memory unit 11 could also include the character memory. The character memory may, for example, be adapted for storing more characters than the characters, which for the moment are visualized on the display. In such a case, the device may be arranged with keys, such as arrows, which can be used for commanding the scroll direction, i.e. in which direction one wishes to direct the text. Thereby, it is possible to view previously fed characters, which have already been shown on the display 12. The display 12 may also be arranged with a key for adjusting its contrast and one for turning on and off the device 1.

The fed characters may be presented at the right end of the display 12, as seen from the operator 40. Thereby, the characters on the display 12 are moved to the left when new characters are fed, in the same manner as during the scrolling. The presentation of the fed characters can also be arranged in such a manner that the first fed character is visualized at the left end of the display 12. Thereby, the character from the next feeding is placed to the right of the previous character such that the characters on the display 12 are added from the left to the right, as seen from the operator 40. When the character row of the displaying unit 12 is filled, the fed characters may be shifted in the same manner as during the scrolling. As an alternative, the display 12 can be arranged so that it erases the shown character row, for example by deletion of the content of the character memory of the display 12. Thereafter, new feedings of characters are built up from the left end of the display 12.

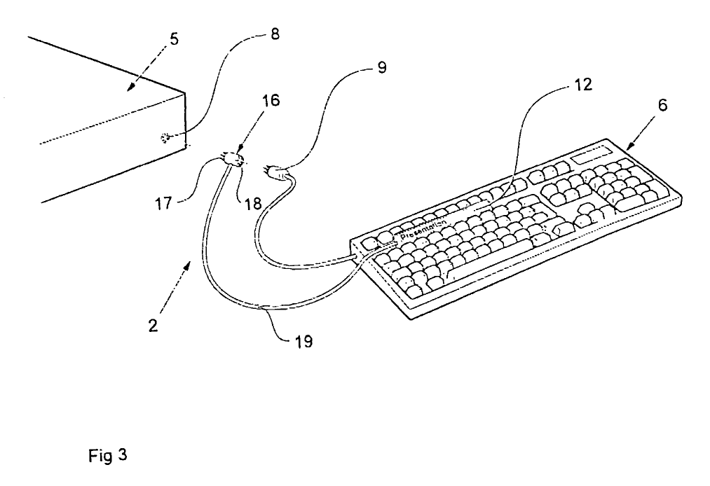

As shown in FIG. 3, the central unit 5 of the computer 3 comprises a connection device 8 for connection to the keyboard 6. An electric voltage that is available in the connection device 8 drives the device 1. Today's computers are usually equipped with such a connection device, which traditionally is used for connection of the keyboard. When connected to a network, the central unit 5 of the computer 3 may be situated in another room than the screen 4 and the keyboard 6, for example in a so-called server room. Then, the connection device 8 is usually connected to the central unit 5 via a wire and is arranged in a wall in connection to the screen 4 and the keyboard 6. The connection device 8 is arranged for receiving a 6-pole DIN-contact 9 having six pins from the keyboard 6. The keyboard 6 uses only four of the six pins of the contact 9. One of those pins is provided with a voltage of 5V.

The connection unit 2 of the device 1 comprises a branch member (not shown), arranged so that it branches the current received from said pin having 5V to the keyboard 6 and to the device 1. Further, the branching member is arranged to provide the display with said data passing from the keyboard to the central unit 5 of the computer 3.

Further, the connection unit 2 comprises an electric wire 19 having a plurality of conductors for transferring different signals associated with said current and said data to the device 1. A number of said connectors connect the branching member and the input port of the one-chip processor 20.

In FIG. 3, a second embodiment of the invention is shown, in which the connection unit 2 comprises a connection member 16 that comprises a first and a second contact member 17, 18. The first contact member 17 is arranged for matching with the connection device 8 of the central unit 5 of the computer 3 and the second contact member 18 is arranged for receiving the DIN-contact 9 from the keyboard 6. In this embodiment, the connection member 16 and the branching member are arranged so that the connection member 16 contains the branching member.

The outer dimensions of the device 1 are relatively small, having a length that depends on the number of characters to be shown on the display 12. The length of the device 1 does not exceed 30 cm or the length of the keyboard 6. The device 1 has a width that makes it possible to locate it in the space between the F-keys and the numerical keys of the keyboard 6, as illustrated in FIG. 1. The height of the device 1 is about 5-20 mm, for example between 10 and 15 mm.

The device 1 comprises a casing 30 adapted for housing the information presenting member, the processing unit 10, and the memory unit 11. The casing 30 may comprise flexible or/and stiff materials.

When the operator is about to use the device 1, according to the first embodiment of the invention, together with a conventional computer 3, he connects the contact 9 of the keyboard to the second contact member 18 of the connection member 16, where after he connects the first contact member 17 of the contact member 16 to the connection device 8 of the central unit 5 of the computer 3. Thus, the device 1 is quickly and simply connected to the computer 3.

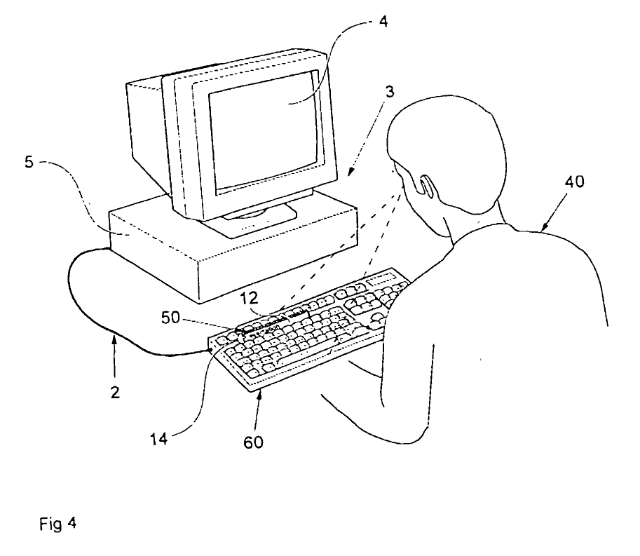

FIG. 4 shows a third embodiment of the invention, in which the device 50 forms an integrated part of the keyboard 60. The processing unit 10, the memory unit 11, and the communication path between them are arranged on a circuit board by use of suitable contacts in the same way as in the above described embodiment. However, in this embodiment the connectors are arranged in the keyboard 60. The display 12, which is connected to the processing unit 10, can be arranged on the keyboard 60 close to the row of numerical keys.

The display 12 may be foldable between an open and a closed position. In its closed position, the display is folded against the keyboard 60 and in the open position, the display is put from the keyboard 60. The display 12 can also be arranged with a screening member 14 for the purpose of showing the feeding of characters only to the operator. The screening member 14 comprises two essentially plane side parts which are arranged at the outer ends of the display 12 and a roof that protrudes over the display 12.

In this embodiment, the branching member is arranged in the keyboard 60. This means that the connection unit 2 in this embodiment does not need any connection member, as in the previous embodiment.

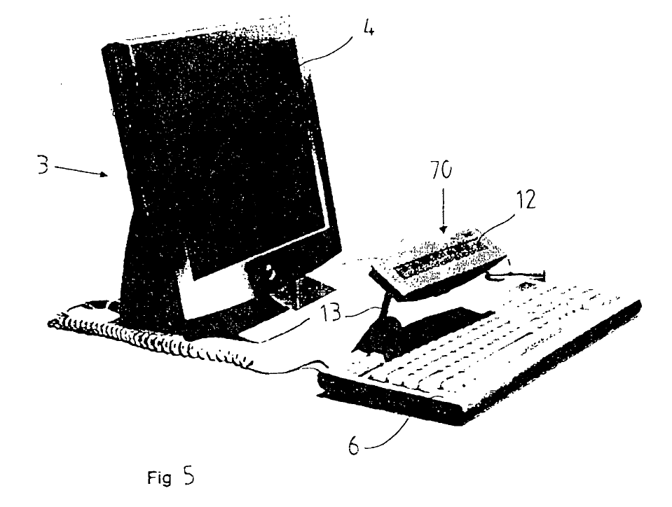

FIG. 5 shows a device 70 according a embodiment of the invention, in which the display 12 is provided on an erected stand 13. The device is not fixed to the keyboard and is thus movable in relation to the keyboard. The display is arranged so that it is possible to tilt and turn it in relation to the stand and thus the operator may adjust it into a desired direction. This embodiment is advantageous since the size of the display is not dependent on the distance between the rows of keys and the position of the display is adjustable in several directions so that the operator can adjust the position of the device until he finds it restful to his eyes.

According to a further embodiment of the invention, the information presenting member comprises a loudspeaker for generation of synthetic speech and thus informs the operator about said characters. The device may also comprise a current source, such as a battery, in case that the voltage received from the computer is not enough, for example when the presentation of fed characters is made utilizing said loudspeaker.

The present invention is not limited to the embodiments disclosed but may be varied and modified within the scope of the following claims. For example, different types of processors, memories, and displays may be used for implementing the invention.

In an embodiment of the invention, the display unit can be a PDA (Personal Digital Assistant), for which the software has been adapted in accordance with the invention.

1. A device for presenting information to a keyboard operator in connection with feeding of characters to a computer that comprises a central unit, a keyboard and a screen, wherein the device is adapted for acting together with the computer and the device comprises a connection unit adapted for connecting the device to the computer and at least one information presenting member, wherein the device is arranged so that it informs the operator about which characters he last fed to the computer, and so that it is possible for the operator to direct his eyes towards the keyboard, meanwhile receiving information about said feeding of characters.

2. A device according to claim 1, wherein the information presenting member comprises a display unit which is arranged for visualizing the feeding of characters within the operator's range of vision when he directs his eyes towards the keys of the keyboard.

3. A device according to claim 2, wherein the displaying unit is located in a rear section of the keyboard such that the displaying unit is located in front of the hands of the operator when he performs the feeding of the characters.

4. A device according to claim 2, wherein the displaying unit is designed to be located between two existing rows of keys on the keyboard.

5. A device according to claim 2, wherein the displaying unit is arranged such that each newly fed character shifts the previously fed characters to the left as seen from the operator.

6. A device according to claim 2, wherein the displaying unit is adapted for showing at most fifty of the latest fed characters.

7. A device according to claim 2, wherein the displaying unit is adapted for showing at least five of the latest fed characters.

8. A device according to claim 2, wherein the displaying unit is provided with a screening member arranged for preventing others than the operator from seeing the visualized characters.

9. A device according to claim 1, wherein the device is integrated in the keyboard.

10. A device according to claim 9, wherein the displaying unit is foldable arranged between an open position and a closed position.

11. A device according to claim 1, wherein the device forms a separate unit relative to the computer and the connection unit is matched to the computer.

12. A device according to claim 1, wherein the connection unit comprises a first contact member for interaction with the computer and a second contact member for interaction with the keyboard.

13. A device according to claim 12, wherein the central unit of the computer comprises a connection device for connection to the keyboard, wherein said first contact member is adapted to fit with the connection device of the computer.

14. A device according to claim 13, wherein the connection unit comprises a branch member, branching the current received from the connection device of the computer to the keyboard and the device.

15. A device according to claim 13, wherein the device is driven by means of an electric voltage available in the connection device of the computer.

16. A device according to claim 1, wherein the device comprises a processing unit for handling data from the character feeding.

17. A device according to claim 16, wherein the device comprises a memory unit interacting with the processing member and adapted for storing data.

18. A device according to claim 17, wherein the memory unit is adapted for storing data corresponding to a plurality of keys, a combination of keys, and instructions regarding how data shall be treated in the processing unit and presented on the displaying unit.

19. A device according to claim 1, wherein the information presenting member comprises means for informing the operator about characters being fed to the computer by means of synthetic speech.

20. A method for presentation of characters, which are fed by an operator via a keyboard to a computer comprising a screen, on which screen the fed characters are presented, wherein the fed characters also are presented visually in immediate connection to the keyboard, so that the operator is allowed to direct his eyes towards the keyboard and type at the same time as he views at least the last fed characters.

21. A method according to claim 20, wherein the fed characters are presented on a device, which is connected to the computer and when the characters are fed by the operator data corresponding to the fed characters are transferred to both the computer and the device.

22. A method according to claim 21, wherein data corresponding to a plurality of characters being defined by the keyboard are stored in the device, and said characters are identified in the device by comparing said data corresponding to the fed characters with the stored data.

23. A method according to claim 22, wherein instructions are stored in the device regarding how data corresponding to fed characters shall be treated and presented and identified data are coupled to certain steps according to the instructions.
